(19) United States
(12) Patent Application Publication
(10) Pub. No.: US 2009/0326868 A1
(43) Pub. Date: Dec. 31, 2009

(54) METHOD FOR SELECTING A TOOLKIT AS WELL AS SYSTEM AND USE THEREOF

(75) Inventors: Franz WALLNER, Rainbach (AT); Christian GUSENBAUER, Freistadt (AT); Wolfgang SAMMINGER, Linz (AT)

Correspondence Address: NIXON & VANDERHYE, PC, 901 NORTH GLEBE ROAD, 11TH FLOOR, ARLINGTON, VA, 22203, US

(73) Assignee: UTIMACO SAFEWARE AG, Oberursel (DE)

(21) Appl. No.: 11/673,372

(22) Filed: Feb. 9, 2007

(30) Foreign Application Priority Data
Feb. 10, 2006 (DE) DE-102006006267.1

(51) Int. Cl. G06F 15/00; G06F 9/44

(52) U.S. Cl. 702/182; 717/124

(57) ABSTRACT

A method is described for selecting a toolkit, preferably a cryptographic toolkit, from a plurality of toolkits, in a computer environment, by providing a test frame, performance characteristics being established for the plurality of toolkits, and the toolkit being determined upon the basis of established parameters for the performance characteristics.

### CROSS REFERENCE TO RELATED PATENT APPLICATION

This application claims the benefit of DE 10 2006 006 267.1, filed Feb. 10, 2006, the entire disclosure of which is incorporated herein by reference.

### FIELD OF THE INVENTION

Certain exemplary embodiments relate to, without limitation, a method for selecting a toolkit, preferably a cryptographic toolkit, a system for selecting a toolkit, and the use of a test frame for same.

### BACKGROUND AND SUMMARY OF THE INVENTION

It is generally known that many toolkits, in particular cryptographic toolkits, are available on the market, but that it is practically impossible to compare them to one another because the product descriptions for the toolkits offer different cryptographic algorithms and partially enable certificate management and elliptic curve cryptography. The conventional toolkits are also offered for different operating systems. However, in the respective product descriptions, one can not find any indication as to which so-called performances values are offered by a toolkit. In particular, it may be useful to know how quickly, for example, a cryptographic toolkit can encrypt data, how much memory it requires for this, and/or how much capacity of the main memory is for encryption.

It is therefore a feature of certain exemplary embodiments to provide a method and a system for selecting toolkits, and a method of use thereof, which enables comparability of the respective toolkits. This and other features may be provided by a method for selecting a toolkit from a plurality of toolkits in a computer environment, the method comprising: providing a test frame which establishes parameters of performance characteristics for the plurality of toolkits; and selecting the toolkit in dependence on a comparison of the established parameters of performance characteristics for the plurality of toolkits. The above and other features may also be provided by a system for selecting a toolkit, preferably a cryptographic toolkit, from a plurality of toolkits in a computer environment, comprising a test frame for establishing performance characteristics for the plurality of toolkits, programmed logic circuiting or circuitry for selecting a toolkit in dependence on the established performance characteristics and an application program suitable for using the selected toolkit. Further, other exemplary features may be obtained from a test frame, for use with the above-described method, operable to establish performance characteristics for toolkits in a computer environment; and the uses wherein further toolkits introduced during operation of the computer environment are taken into consideration when selecting the toolkit.

According to the application of certain exemplary embodiments, a test frame is provided which establishes performance characteristics for a plurality of toolkits. The selection of the toolkit to be used is determined upon the basis of parameters established for the performance characteristics. In this way, in a respective computer environment in which a plurality of toolkits are available, by implementing a test frame the most suitable toolkit for the user can be selected dependently upon the pre-selection of the parameters established for the performance characteristics. By implementing the test frame which establishes the performance characteristics of the respective toolkits, for example, it is possible to choose between a toolkit (A) and (B) even though a toolkit (A) is for example the quickest when encrypting small quantities of data, whereas toolkit (B) in turn, encrypts substantially faster when encrypting large quantities of data, for example. By means of the comparison possibilities and the associated possibility of selecting a toolkit from a plurality of toolkits, the performance of the overall system of a computer environment is enhanced. When establishing the performance characteristics for the plurality of toolkits, for example, not only is the encryption time used as a criterion, but also, for example, the memory requirement or the utilized capacity of the main memory.

When configuring both hardware and software, a selection according to the application of the toolkits can advantageously take into consideration, and so enhance, the performance capability of the whole system, and not just special configurations in a computer environment.

Advantageously, the established parameters are determined by the function or the functionalities of the plurality of toolkits by means of at least one wrapper. The wrapper may be considered as a component which encapsulates a specific functionality, for example the functions of the toolkits. It has also advantageously emerged that a specific wrapper can be provided for each toolkit so that special functionalities can be encapsulated for each toolkit, and so the comparability can be standardized, if so required. If platform-dependent wrappers are additionally introduced, according to the application, different platforms can be operated, a platform here being considered as the operating system including the hardware provided. The application possibilities can therefore be increased in this way.

Advantageously, a toolkit is determined upon the basis of a statistical evaluation of the parameters. With this determination of the toolkit, when considering statistics the fundamentals in particular are considered, e.g., upon the basis of a repeated calculation method, the maximum, minimum, variance and arithmetical means are considered.

A further advantageous possibility for determining the toolkit is implemented upon the basis of an algorithmic evaluation of the parameters, with which a prognosis for the respective toolkits can be produced, it being possible for the statistical evaluations to still be algorithmically linked to and summarised with system and environment data.

Furthermore, if the toolkit is determined upon the basis of a self-learning interrogation, the tool selection method will be optimised during the operation of the computer environment, and so constantly differing requirement factors will be taken into account.

It has also proved to be advantageous if the toolkit is determined dynamically in a computer environment. For example, when extending with changes and/or making changes to toolkits, the toolkit determined or selected can be checked again and so re-established and selected without the whole system having to be considered again.

Performance characteristics for symmetrical encryption, symmetrical decryption, hashing and/or random number generation are established as advantageous encryption methods for the toolkits. On the other hand, performance characteristics may be advantageously established for asymmetrical encryption and/or signatures.

It may be an advantageous further development that the test frame only communicates with the wrapper via defined interfaces or toolkit-independent interfaces, whereas this wrapper converts a defined interface or toolkit-independent interface into the toolkit-specific interfaces. In this way, a clear separation between the wrappers and establishing the performance characteristics by the test frame is also guaranteed. Furthermore, the wrappers can therefore also be used independently of the performance characteristics analysis.

It is also advantageous that means are disclosed for storing parameters determined so that the established performance characteristics are available at any time.

Further advantageous embodiments will become apparent from this description and the appended claims.

### BRIEF DESCRIPTION OF THE DRAWINGS

The subject matter of the application is described by means of an advantageous embodiment using the attached drawings, in which:

FIG. 1 schematically depicts the architecture of a system according to the application.

FIG. 2 depicts a flowchart for establishing performance characteristics of an exemplary embodiment.

### DETAILED DESCRIPTION OF PREFERRED EMBODIMENTS

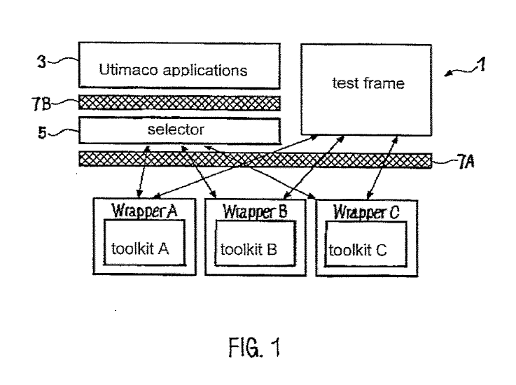

In FIG. 1, the architecture of the system according to the application of a computer environment with a test frame 1 for establishing performance characteristics for the plurality of toolkits (A), (B), (C) and an application program 3 with a separately shown selector 5, but which can also be integrated into the application program, is provided. The application program with the selector selects the toolkit upon the basis of the performance characteristics or the parameters for the performance characteristics established, and uses the selected toolkit. Corresponding interfaces 7a and 7b are also shown by grey areas, interface 7b not necessarily being required, being useful when the selector is provided separately to the application program. In the embodiment shown in FIG. 1, a so-called wrapper is shown for each toolkit which communicates via the interface 7a with the application program or selector for the application program and the test frame 1. As can be clearly seen, the test frame 1 is provided such that it only establishes the performance characteristics, and does not undertake any evaluation, however, and also does not select the toolkits upon the basis of the performance characteristics.

The following values, for example, can form part of the toolkit-specific performance characteristics, e.g., accuracy, processing speed, CPU capacity utilization, statistical RAM, dynamic RAM, power consumption, number of threads, handles and processes. Within the framework of the statistical evaluation, these toolkit data are asked for n times, and this can be set by the user of the cycles. This gives the subsequent statistical values such as minimum, maximum, arithmetical medium and variance. The result of these statistical values is then used as established parameters for the performance characteristics in order to determine the toolkit. The test frame 1 communicates via a toolkit-independent interface with the wrapper, the wrappers converting this independent interface into the toolkit-specific interface. By means of this step it is possible for the parameters of the performance characteristics established to be able to be prepared in a specific application context, and so comparability between the respective toolkits is also available. The presence of the toolkit-independent interface means that each toolkit actually being used or selected is kept totally transparent for the application program. The toolkit-specific data are concealed by the wrappers.

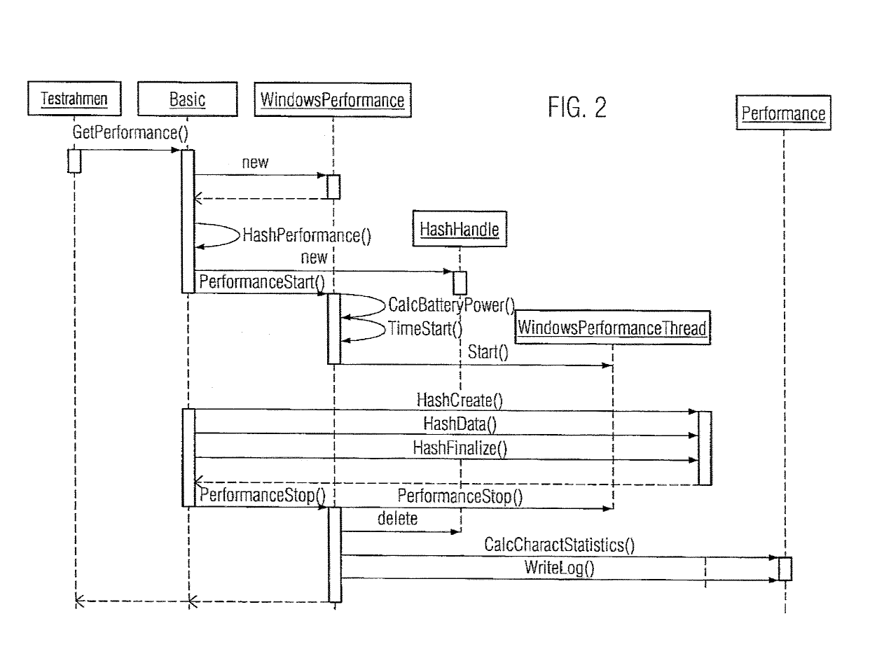

FIG. 2 shows an example of an application for the procedure for establishing the performance characteristics for “Hash Functions”. It is pointed out here that no toolkit-specific wrapper object is specified so as to make it clear that the performance characteristics can be calculated independently of the wrapper. After determining in the main part of the application program from how many individual values the statistics of the performance characteristics are to be calculated, further means are provided for storing performance characteristics. According to FIG. 2, the “GetPerformance” method is selected in the test frame, with which one is given the file names which are made available by the means for storing the performance data, and the number of cycles. The method and interrogation shown here provides in a first output parameter the machine-specific performance characteristics, and in a second output parameter the toolkit-specific performance characteristics.

In the test frame, the aforementioned method is implemented under the “wrapper” classification. The test frame generates a platform or operating system-dependent “WindowsPerformance” object for establishing the performance characteristics. The number of cycles, the name of the test data file and the name of the file for storing the individual values are given with the “WindowsPerformance”. Then the machine-specific performance characteristics are established. Then the “Hash Performance” method is selected which calculates the performance characteristics for “Hash Functions”. There are in addition the “EncryptPerformance”, “DecryptPerformance” and “RNDPerformance” methods which establish the performance characteristics for the encryption, decryption and for random number generation. These are not shown in FIG. 2. The performance methods may be structured according to the following scheme: There is a loop which passes through all of the operations being implemented according to this embodiment. In this loop, the accuracy of a cryptographic algorithm is first of all checked. If the accuracy test is failed, for these operations no performance characteristics are calculated. If the accuracy test is positive, the toolkit-specific performance characteristic is correctly set. After this, a “HashHandle” is generated. This “HashHandle” is used for all of the hash functions in this loop. It is only deleted at the end of the loop. Following this, the “Performance-Start” method is selected. This starts establishing the performance characteristics. The “WindowsPerformance” object first of all asks for, for example, the current Accu status of the battery with the “CalcBatteryPower” method when the computer is running on Accu. The time measurement is then started with the help of the “TimeStart” method. A distinct thread, the “WindowsPerformanceThread” establishes, concurrently with the hashing, the remaining toolkit-specific performance characteristics such as the main memory utilized capacity and the memory requirement. This is generated with the “Start” method. Only then, because many cryptographic functions are so fast that they partially allow the “PerformanceThread” no time to start, the hashing is started. For this, three method selections are required which are passed on in an appropriate form to the toolkit. The “HashCreate” method initialises the “HashHandle”, the “HashData” method implements the hashing, and the “HashFinalize” method ends the hashing and provides the hash value. Immediately after the “HashFinalize” method returns, the “PerformanceThread” is stopped. If the “PerformanceThread” has not yet established all of the performance characteristics, the main thread must wait for it. Time measurement is also paused. Only when the loop has been run through cycle number times, and performance characteristics have been established in the outer loop for all data values, the “HashHandle” is deleted, and the statistical values are calculated. The “CalcCharactStatistics” method calculates the minimum, the maximum, the average value and the variance of the performance characteristics of the current operation, and stores them in the initial parameters. The “WriteLogFile” method writes all of the individual values for the current operation in the specified file. Only when performance characteristics can be established for all operations are the performance characteristics released by the test frame.

In summary, it should be noted that, according to the application, it is proposed to provide a test frame which establishes performance characteristics of toolkits, preferably cryptographic toolkits. Upon the basis of the performance characteristics calculated, it should be possible to select the toolkit which best implements a cryptographic function. For this feature, the following exemplary approach may be implemented:
Analyze toolkits
Define performance characteristics
Define interface between the “Basic Infrastructure” and the toolkits
Implement wrapper for the “cryptlib” toolkit
Provide test frame for the Windows operating system
Port test frame and wrapper to further operating systems.

In the first step, different cryptographic toolkits made by different manufacturers are analyzed. Commonly used algorithms such as AES, triple DES and RSA are offered by all analyzed toolkits. The certificate management and the ability to run on different operating systems are not made possible by all toolkits.

After this, performance characteristics are defined for the toolkits. The machine-specific performance characteristics, such as the type of operating system and the processor type remain the same during an algorithm selection. The toolkit-specific performance characteristics, such as the CPU utilized capacity, change, however, with every selection.

In the next step an interface is provided between the “Basic Infrastructure” and the wrappers. Next, a wrapper is developed independently of the platform for a toolkit, and this implements the essential parts of this interface.

For example, and without limitation, a test frame for the Windows operating system may be developed which establishes the performance characteristics of cryptographic toolkits. The test frame is largely implemented independently of the platform. Only hardware-specific information for the performance characteristics is established dependently upon the operating system.

The test frame establishes the performance characteristics and calculates the parameters of the performance characteristics for the plurality of toolkits. These performance characteristics and parameters of the performance characteristics are, for example, made available to the selector so as to offer a specific algorithm with a fixed mode, encryption and block length with the highest performance based upon this. It is by all means possible for a toolkit “y” to encrypt large quantities of data with considerably higher performance than a toolkit “x”, whereas with small quantities of data it is possible for toolkit “x” to encrypt with higher performance than toolkit “y”. Here, not only is the encryption time a criterion, but also the memory requirement or the utilized capacity of the main memory. A toolkit “z” can best shorten by encrypting with algorithm “a” and mode “b”, whereas toolkit “f” is better when encrypting with the same algorithm “(a)” but with another mode “c”.

In compliance with applicable statute, certain exemplary embodiments have been described in language more or less specific as to structural and/or methodical features. It is to be understood, however, that the features are not limited to specific features shown and described hereinabove, since the methods, systems, devices and uses disclosed comprise preferred forms of putting certain features into effect. The exemplified embodiments are therefore claimed in any of its forms or modifications within the proper scope of the appended claims appropriately interpreted in accordance with the doctrine of equivalents. While the above-illustrated embodiments has been described, those skilled in the art will recognize that the features are not limited to the embodiments described. The described and other features can be practiced with modification and alteration within the spirit and scope of the appended claims. This written description is to be regarded as illustrative instead of restrictive on the present invention.

What is claimed is:

1. A method for selecting a toolkit from a plurality of toolkits in a computer environment, the method comprising:
a) providing a test frame which establishes parameters of performance characteristics for the plurality of toolkits;
b) selecting the toolkit in dependence on a comparison of the established parameters of performance characteristics for the plurality of toolkits.

2. The method according to claim 1, wherein the toolkit to be selected is a cryptographic toolkit.

3. The method according to claim 1, wherein the established parameters being determined by functions of the plurality of toolkits captured by at least one wrapper, preferably a platform-independent wrapper.

4. The method according to claim 1, wherein the comparison is statistical evaluation of the parameters.

5. The method according to claim 1, wherein the comparison is an algorithmic evaluation of the parameters.

6. The method according to claim 1, wherein the comparison is a self-learning interrogation.

7. The method according to claim 1, wherein the toolkit is selected dynamically.

8. The method according to claim 1, further comprising introducing additional toolkits during operation of the method and including said additional toolkits during the selecting step.

9. The method according to claim 1, further establishing performance characteristics for symmetrical encryption, symmetrical decryption, hashing and/or random number generation.

10. The method according to claim 1, further establishing performance characteristics for asymmetrical encryption and/or signatures.

11. The method according to claim 3, wherein the test frame only communicating with the wrappers via defined interfaces, preferably toolkit-specific interfaces.

12. A system for selecting a toolkit, preferably a cryptographic toolkit, from a plurality of toolkits in a computer environment, comprising a test frame for establishing performance characteristics for the plurality of toolkits, programmed logic circuiting for selecting a toolkit in dependence on the established performance characteristics and an application program suitable for using the selected toolkit.

13. The system according to claim 12, further comprising at least one wrapper is provided for the toolkits.

14. The system according to claim 12, further comprising a toolkit-independent interface.

15. The system according to claim 12, further comprising storage locations for storing established parameters determined by functions of the plurality of toolkits.

16. The system according to claim 12, wherein the test frame is implemented in the computer environment independently of the platform.

17. The system according to claim 13, wherein the wrapper is implemented independently of the platform.

18. The system according to claim 12, further comprising evaluating programmed logic circuiting for evaluating the established performance characteristics.

19. The system according to claim 18, wherein the programmed logic circuiting is operable to dynamically evaluate the established performance characteristics.

20. A test frame, for use with the method according to claim 1, operable to establish the performance characteristics of toolkits in a computer environment.

21. The use according to claim 20, wherein further toolkits are introduced during operation of the computer environment and taken into consideration when selecting the toolkit.

22. A test frame for use with the system according to claim 12, operable to establish the performance characteristics of toolkits in a computer environment.

23. The method according to claim 3, wherein each said wrapper is a platform-independent wrapper.

24. The method according to claim 11, wherein each of said interface is a toolkit-specific interface.

25. A system according to claim 12, wherein the toolkit is a cryptographic toolkit.
